(19) United States
(12) Patent Application Publication
(10) Pub. No.: US 2013/0052497 A1
(43) Pub. Date: Feb. 28, 2013

(54) AIR VALVE FOR ENERGY STORAGE DEVICE AND ENERGY STORAGE DEVICE INCLUDING THE SAME

(71) Applicants: Jung Eun NOH, Gyeonggi-do (KR); Sung Yeol PARK, Gyeonggi-do (KR); Yeong Su CHO, Gyeonggi-do (KR)

(72) Inventors: Jung Eun NOH, Gyeonggi-do (KR); Sung Yeol PARK, Gyeonggi-do (KR); Yeong Su CHO, Gyeonggi-do (KR)

(21) Appl. No.: 13/420,543

(22) Filed: Mar. 14, 2012

(30) Foreign Application Priority Data
Aug. 29, 2011 (KR) 10-2011-0086531

(51) Int. Cl. H01M 2/12; F16K 31/08; H01G 9/004; F16K 17/02

(52) U.S. Cl. 429/82; 251/65; 137/528; 361/502

(57) ABSTRACT

Disclosed herein is an air valve for an energy storage device, including: a valve body mounted in a gas vent of an energy storage device and having a passage for discharging gases within the gas vent to the outside; and a plurality of magnets mounted within the passage to apply repulsion force to one another so as to block the gas vent from the outside by the repulsion force and communicate the gas vent with the outside when a gas pressure within the gas vent is larger than the repulsion force, thereby discharging gases. By this configuration, exemplary embodiments of the present invention can configure the air valve with the simple structure capable of smoothly discharging gases generated from the energy storage device while minimizing a volume of the air valve and being semi-permanently used while minimizing a mechanical configuration of the air valve.

### CROSS REFERENCE(S) TO RELATED APPLICATIONS

This application claims the benefit under 35 U.S.C. Section 119 of Korean Patent Application Ser. No. 10-2011-0086531, entitled “Air Valve For Energy Storage Device And Energy Storage Device Including The Same” filed on Aug. 29, 2011, which is hereby incorporated by reference in its entirety into this application.

### BACKGROUND OF THE INVENTION

1. Technical Field

The present invention relates to an air valve for an energy storage device and an energy storage device including the same, and more particularly, to an air valve for an energy storage device and an energy storage device including the same capable of smoothly discharging gases generated from the energy storage device while minimizing a volume of the air valve with a simple structure and being semi-permanently used while minimizing a mechanical configuration thereof.

2. Description of the Related Art

Recently, with the technology development of electric and electronic communication fields, various types of mobile electronic products have been released and applications of an energy storage device such as a secondary battery, or the like, have been expanded.

In addition, as the focus on environmental problems and resource problems has been increased, the competition for developing a technology relating to a car using environmentally friendly energy or environmentally friendly production such as solar power generation, or the like, is intensifying.

A representative example of an electric energy storage device that has been the most widely used up to the present may include a secondary battery that may be used for a long period for time through charging and discharging. The secondary battery may maintain an output at predetermined voltage for a relatively long period of time and may be manufactured to have a small and light structure and thus, has been widely used as a power storage device for small mobile devices.

Meanwhile, the secondary battery may have disadvantages in that time consumed to perform charging and discharging is relatively long, output voltage is as low as about 3V, a lifespan is short, a risk of explosion is large, or the like, such that the secondary battery has a limitation in applications.

As the energy storage device capable of supplementing the disadvantages of the above-mentioned secondary battery, an interest in a supercapacitor performing a charging and discharging operation by an electrochemical mechanism has been increased.

There are various types of supercapacitors, such as an electric double layer capacitor (EDLC), a hybrid capacitor, a pseudo-capacitor, or the like. The supercapacitor can implement instantaneous charging, more excellent output characteristics than the secondary battery, and a longer lifespan than the secondary battery.

Considering the above-mentioned advantages, research into the supercapacitor to be used as regenerative braking for a car has been conducted.

Meanwhile, the energy storage devices such as the secondary battery, the supercapacitor, or the like, has an electrolytic solution (or electrolyte) between electrodes and performs the charging and discharging process by the electrochemical mechanism. In this case, various gases may be generated. Therefore, when these gases are not appropriately discharged, a case of the energy storage device is ruptured, such that the energy storage device may not be used anymore or in extreme cases, may be exploded.

The supercapacitor does not completely solve problems such as energy density, resistance, or the like, such that it is difficult to smoothly commercialize the supercapacitor. However, the supercapacitor is expected to be commercialized in the near future. Therefore, there is a need to solve problems of degradation in reliability and reduction in lifespan due to the gas generation as described above.

FIG. 1 shows a configuration of a valve disclosed in KR Patent Application No. 2003-47556 proposed to solve the above-mentioned problems.

Referring to FIG. 1, the air valve disclosed in the above Patent Document uses a method for discharging gases by rupturing a metal thin film when a pressure is increased due to the gases generated from the inside of the energy storage device. When the method is used, maintenance costs may be increased and maintenance may be complicated since the metal thin film needs to be replaced each time the metal thin film is ruptured.

### SUMMARY OF THE INVENTION

An object of the present invention provides an air valve for an energy storage device and an energy storage device including the same capable of being semi-permanently used while maintaining an internal pressure of the energy storage device within a predetermined range.

Another object of the present invention provides an air valve for an energy storage device and an energy storage device including the same capable of smoothly discharging gases generated from the energy storage device while minimizing a volume of the air valve with a simple structure.

According to an exemplary embodiment of the present invention, there is provided an air valve for an energy storage device, including: a valve body mounted in a gas vent of an energy storage device and having a passage for discharging gases within the gas vent to the outside; and a plurality of magnets mounted within the passage to apply repulsion force to one another so as to block the gas vent from the outside by the repulsion force and communicate the gas vent with the outside when a gas pressure within the gas vent is larger than the repulsion force, thereby discharging gases.

The valve body may include an inlet formed at one side of the passage and an outlet formed at the other side of the passage and the plurality of magnets may include fixed magnets having a connection passage mounted at the other side of the passage and communicating with the outlet and a moving magnet mounted at one side of the passage to block the inlet by the repulsion force acting between the fixed magnets.

An edge of the moving magnet may be provided with at least one communication groove for communicating the inlet with the connection passage at the time of discharging gases by communicating the gas vent with the outside.

The plurality of magnets may include a permanent magnet. According to another exemplary embodiment of the present invention, there is provided an energy storage device, including: a main body accommodating a plurality of electric cells and having a gas vent mounted at one side thereof; and an air valve including a valve body mounted in a gas vent of an energy storage device and having a passage for discharging gases within the gas vent to the outside and a plurality of magnets mounted within the passage to apply repulsion force to one another so as to block the gas vent from the outside by the repulsion force and communicate the gas vent with the outside when a gas pressure within the gas vent is larger than the repulsion force, thereby discharging gases.

### BRIEF DESCRIPTION OF THE DRAWINGS

FIG. 1 is across-sectional view schematically showing an air valve for an energy storage device according to the related art.

FIG. 2 is a cross-sectional view schematically showing an air valve for an energy storage device according to an exemplary embodiment of the present invention.

FIG. 3 is a cross-sectional view showing a case in which gases are discharged to the outside by communicating an inlet and an outlet by moving a moving magnet upwardly when a gas pressure within a gas vent is higher than a predetermined pressure in FIG. 2.

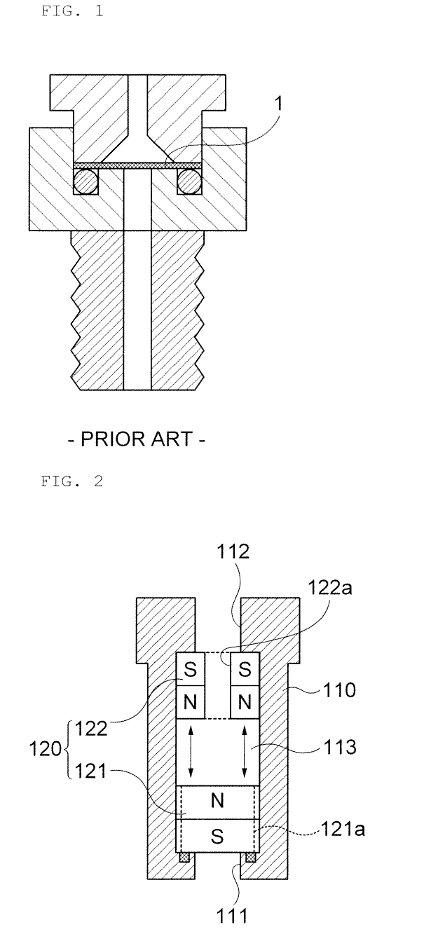

### DESCRIPTION OF THE PREFERRED EMBODIMENTS

Hereinafter, exemplary embodiments of the present invention in which objects of the present invention may be specifically implemented will be described with reference to the accompanying drawings. In exemplary embodiments of the present invention, the same terms and reference numerals will be used to describe the same components. Therefore, an additional description for the same component will be omitted below.

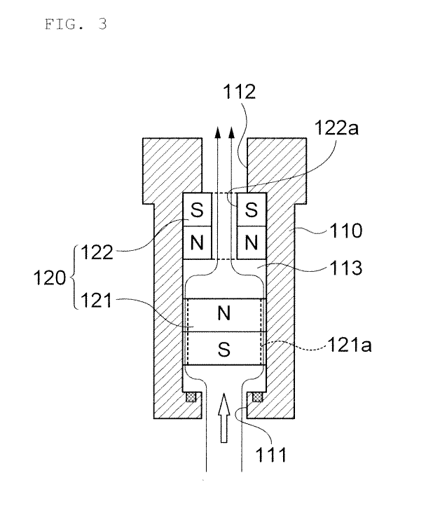

An air valve for an energy storage device and an energy storage device including the same according to an exemplary embodiment of the present invention will be described in more detail with reference to FIGS. 2 and 3.

FIG. 2 is a cross-sectional view schematically showing an air valve for an energy storage device according to an exemplary embodiment of the present invention and FIG. 3 is a cross-sectional view showing a case in which gases are discharged to the outside by communicating an inlet with an outlet by moving a moving magnet upwardly when a gas pressure within a gas vent is higher than a predetermined pressure in FIG. 2.

Referring to FIG. 2, an air valve for an energy storage device according to an exemplary embodiment of the present invention is included in a gas vent of the energy storage device such as a secondary battery, a supercapacitor, or the like, in order to discharge gases to the outside when a gas pressure generated from the inside of the energy storage device is a predetermined pressure or more.

In more detail, the air valve for the energy storage device according to the exemplary embodiment of the present invention may be configured to largely include a valve body 110 and a plurality of magnets 120.

The valve body 110 has a lower portion inserted into the gas vent of the energy storage device and may have a passage 113 for discharging gases within the gas vent to the outside.

In this configuration, one side of the passage 113, that is, a lower end of the valve body 110 is provided with an inlet 111 and the other side of the passage 113, that is, an upper end of the valve body 110 may be provided with an outlet 112.

The plurality of magnets 120 is mounted in the passage 113 of the valve body 110 so as to apply repulsion force to one another. By this configuration, the plurality of magnets serves to block the gas vent from the outside by the repulsion force acting on one another and communicate the gas vent with the outside when the gas pressure within the gas vent is larger than the repulsion force to discharge gases to the outside.

Here, the plurality of magnets 120 may include fixed magnets 122 mounted at the other side of the passage 113, that is, at the outlet 112 and moving magnets 121 at one side of the passage 113, that is, at the inlet 111.

In this case, a center of the fixed magnets 122 may be provided with a connection passage 122a communicating with the outlet 112 and an edge of the moving magnet 121 may be provided with at least one communication groove 121a for communicating the inlet 111 with the connection passage 122a at the time of discharging gases by communicating the gas vent with the outside.

That is, the moving magnet 121 maintains the inlet 111 at a blocking state within the passage 113 by the fixed magnets 122 and the repulsion force at normal times. In this state, when the gas pressure is larger than the repulsion force due to the increase in the gas pressure within the gas vent to a predetermined pressure (setting discharge pressure) or more, as shown in FIG. 3, the moving magnet 121 moves to the fixed magnets 122 by the gas pressure to open the inlet 111.

Then, the gases within the gas vent maybe discharged to the outside by passing through the inlet 111, the communication groove 121a of the moving magnet 121, the passage 113, the connection passage 122a of the fixed magnets 122, and the outlet 112 in order.

Thereafter, when the gas pressure is smaller than the repulsion force by reducing the gas pressure within the gas vent to a predetermined pressure (setting return pressure) or less, as shown in FIG. 2, the moving magnet 121 move in a direction far away from the fixed magnets 122 by the repulsion force with the fixed magnets 122 to close, that is, block the inlet 111.

Meanwhile, the plurality of magnets 120, that is, the fixed magnets 122 and the moving magnet 121 may be formed of a permanent magnet, but is not limited thereto. Although not shown in detail, as the magnets 120, an electromagnet, or the like, may also be applied.

The air valve for an energy storage device according to the exemplary embodiment of the present invention uses the repulsion force generated between the fixed magnets 122 and the moving magnet 121 to more easily match a central align of the moving magnet 121 within the passage 113 of the valve body 110 and can be used under the high pressure even though the attraction and the repulsion force of the magnet have the same magnetic force, as compared with the case using the attraction of the magnet.

That is, when the repulsion force of the same magnetic force as attraction, the air valve can be used under the high pressure about 4 to 6 times higher than the attraction. For example, the air valve can be used under the gas pressure of 0.5 kgf/cm² when the attraction is used; however, the air valve can be used under the gas pressure of 2 to 3 kgf/cm² hen the same size of repulsion force is applied to the air valve.

As set forth above, the air valve for energy storage device and the energy storage device including the same according to the exemplary embodiments of the present invention can appropriately solve the increase in internal pressure due to the gases generated from the energy storage device while minimizing the volume of the air valve with the simple structure so as to improve the reliability of the energy storage device and can semi-permanently use the air valve to save the maintenance costs and improve the maintenance capability

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

What is claimed is:

1. An air valve for an energy storage device, comprising:
a valve body mounted in a gas vent of an energy storage device and having a passage for discharging gases within the gas vent to the outside; and
a plurality of magnets mounted within the passage to apply repulsion force to one another so as to block the gas vent from the outside by the repulsion force and communicate the gas vent with the outside when a gas pressure within the gas vent is larger than the repulsion force, thereby discharging gases.

2. The air valve for an energy storage device according to claim 1, wherein the valve body includes an inlet formed at one side of the passage and an outlet formed at the other side of the passage and the plurality of magnets include fixed magnets having a connection passage mounted at the other side of the passage and communicating with the outlet and a moving magnet mounted at one side of the passage to block the inlet by the repulsion force acting between the fixed magnets.

3. The air valve for an energy storage device according to claim 2, wherein an edge of the moving magnet is provided with at least one communication groove for communicating the inlet with the connection passage at the time of discharging gases by communicating the gas vent with the outside.

4. The air valve for an energy storage device according to any one of claims 1 to 3, wherein the plurality of magnets include a permanent magnet.

5. An energy storage device, comprising:
a main body accommodating a plurality of electric cells and having a gas vent mounted at one side thereof; and
an air valve including a valve body mounted in a gas vent of an energy storage device and having a passage for discharging gases within the gas vent to the outside and a plurality of magnets mounted within the passage to apply repulsion force to one another so as to block the gas vent from the outside by the repulsion force and communicate the gas vent with the outside when a gas pressure within the gas vent is larger than the repulsion force, thereby discharging gases.
